(19) United States
(12) Patent Application Publication
(10) Pub. No.: US 2026/0030428 A1
(43) Pub. Date: Jan. 29, 2026

(54) AUTOMATED ADDITION OF POWER SUPPLY RAIL, FENCE AND LEVEL TRANSLATORS IN A CIRCUIT DESIGN

(71) Applicant: International Business Machines Corporation, Armonk, NY (US)

(72) Inventors: Gabor Drasny, Poughkeepsie, NY (US); Klaus-Dieter Schubert, Schoenaich (DE); Gabor Bobok, Adirondack, NY (US); Benedikt Geukes, Stuttgart (DE)

(21) Appl. No.: 18/783,507

(22) Filed: Jul. 25, 2024

(51) Int. Cl. G06F 30/396; G06F 30/343; G06F 119/18

(52) U.S. Cl. CPC G06F 30/396; G06F 30/343; G06F 2119/18

(57) ABSTRACT

A computer-implemented method for automating addition of power supply rails, fences, and level translators in a circuit design, includes annotating initial component instance pins as belonging to a design region based on user specification and connectivity tracing with a design region. The design region is a clock region and global voltage domain pair. The method propagates a design region forward from the component instance pins to sequential components by assigning a design region to a sequential component based on the design region of a previous component, identifies crossing endpoints where the design region changes and places at least one of a fence, power supply rail, and a level translator at the crossing endpoints.

### BACKGROUND

The present invention generally relates to automated circuit design, and more specifically, to automatically determining positions and connections for power supply rails, fences and level translators in the circuit design.

Microprocessors, and other similar circuits, use logic gates constructed from transistors, resistors capacitors, inductors, and other electronic components arranged in a circuit. As such circuits get more complex due to technology increases, the positioning and connection of certain components including power supplies, clock region fences, and voltage level translators gets more cumbersome and reliance on entirely manual positioning in a design can increase the possibility of human error. To counteract this, some circuit design systems utilize automated or partially automated systems to add fences, level translators and power supply rails to a circuit design.

### SUMMARY

Embodiments of the present invention are directed to a computer-implemented method for automating addition of power supply rails, fences, and level translators in a circuit design. A non-limiting example of the computer-implemented method includes annotating initial component instance pins as belonging to a design region based on user specification and connectivity tracing with a design region. The design region is a clock region and global voltage domain pair. The method propagates a design region forward from the component instance pins to sequential components by assigning a design region to a sequential component based on the design region of a previous component, identifies crossing endpoints where the design region changes and places at least one of a fence, power supply rail, and a level translator at the crossing endpoints.

Embodiments of the present invention are further directed to systems and computer program products for automating addition of power supply rails, fences, and level translators in a circuit design.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of an exemplary modular circuit design;

FIG. 2 depicts a high level process flow for automatically updating a circuit design;

FIG. 3 depicts an exemplary XOR gate including inputs having different design regions;

FIG. 4 depicts a block diagram of a system 100 to perform the automated addition of power supply rails, fences and level translators according to embodiments of the invention;

FIG. 5 depicts a process flow of a method of fabricating the integrated circuit according to exemplary embodiments of the invention;

FIG. 6 depicts a computer system configured to implement a disclosed embodiment.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

In some embodiments disclosed herein, a computer-implemented method for automating addition of power supply rails, fences, and level translators in a circuit design. The computer-implemented method comprises annotating initial component instance pins as belonging to a design region based on user specification and connectivity tracing with a design region, the design region being a clock region and global voltage domain pair, propagating a design region forward from the component instance pins to sequential components by assigning a design region to a sequential component based on the design region of a previous component, identifying crossing endpoints where the design region changes, and placing at least one of a fence, power supply rail, and a level translator at the crossing endpoints. The computer-implemented method advantageously increases an efficiency of circuit designs, and minimizes instances of human error in the same.

In further embodiments, the initial component instance pins are clock sources, thereby facilitating the propagation process beginning at original starting points within the circuit design.

In further embodiments, propagating the design region forward from the component instance pins to sequential components includes: responsive to a buffer setting the clock region of a design region of the buffer as the clock region of a preceding component and determining that a voltage using one of a voltage crossing table and a default voltage defined by a user, responsive to a logic gate having a set of inputs and each input having a same design region setting a design region of an output of the logic gate as the same design region. Propagating the design region forward allows the process to track a design region through the circuit design thereby providing a logical flow tracing of the design regions.

In further embodiments, propagating the design region forward from the component instance pins to sequential components includes: responsive to a buffer setting the clock region of a design region of the buffer as the clock region of a preceding component and determining that a voltage using one of a voltage crossing table and a default voltage defined by a user, responsive to the logic gate having a set of inputs and at least one input of the set of inputs having a distinct design region from at least one other input of the set of inputs, setting a design region of an output of the logic gate as an optimal design region based at least in part on an integer score of each design region. Propagating the design region forward allows the process to track a design region through the circuit design thereby providing a logical flow tracing of the design regions.

In further embodiments, the integer score of each design region is a lexicographically ordered tuplet, advantageously allowing a ranking of the possible design regions.

In further embodiments, the lexicographically ordered tuplet includes a total number of clock region crossings and a total number of voltage domain crossings from an input of the component to an output of the component advantageously allowing for the ranking to be at least partially based on the number of clock region crossings.

In further embodiments, the lexicographically ordered tuplet includes a set of crossing types of clock region crossings and voltage domain crossings advantageously allowing for the ranking to be at least partially based on the crossing types and voltage domain crossings.

In further embodiments, the lexicographically ordered tuplet includes a number of violations of at least one of a set of predetermined fencing compatibility rules, advantageously allowing the ranking to be based at least partially on a number of violations introduced by the circuit design.

In further embodiments, the lexicographically ordered tuplet includes an availability of clock regions and voltage domains in instances enclosing the logic gate advantageously allowing the ranking to be based at least partially on the availability of the design region for the logical component.

In another embodiment, a computer-program product includes instructions for causing a computer system to perform a method including receiving initial component instance pins annotations the initial component as belonging to a design region based on user specification and connectivity tracing with a design region, the design region being a clock region and global voltage domain pair, propagating a design region forward from the component instance pins to sequential components by assigning a design region to a sequential component based on the design region of a previous component, identifying crossing endpoints where the design region changes, and placing at least one of a fence, power supply rail, and a level translator at the crossing endpoints. The computer-program product advantageously facilitates the distribution of instructions to multiple computer systems.

In further embodiments, the initial component instance pins are clock sources, thereby facilitating the propagation process beginning at original starting points within the circuit design.

In further embodiments, propagating the design region forward from the component instance pins to sequential components includes: responsive to a buffer setting the clock region of a design region of the buffer as the clock region of a preceding component and determining that a voltage using one of a voltage crossing table and a default voltage defined by a user, responsive to a logic gate having a set of inputs and each input having a same design region setting a design region of an output of the logic gate as the same design region, and responsive to the logic gate having a set of inputs and at least one input of the set of inputs having a distinct design region from at least one other input of the set of inputs, setting a design region of an output of the logic gate as an optimal design region based at least in part on an integer score of each design region. Propagating the design region forward allows the process to track a design region through the circuit design thereby providing a logical flow tracing of the design regions.

In further embodiments, the integer score of each design region is a lexicographically ordered tuplet, advantageously allowing a ranking of the possible design regions.

In further embodiments, the lexicographically ordered tuplet includes a total number of clock region crossings and a total number of voltage domain crossings from an input of the component to an output of the component advantageously allowing for the ranking to be at least partially based on the number of clock region crossings.

In further embodiments, the lexicographically ordered tuplet includes a set of crossing types of clock region crossings and voltage domain crossings advantageously allowing for the ranking to be at least partially based on the crossing types and voltage domain crossings.

In further embodiments, the lexicographically ordered tuplet includes a number of violations of at least one of a set of predetermined fencing compatibility rules, advantageously allowing the ranking to be based at least partially on a number of violations introduced by the circuit design.

In further embodiments, the lexicographically ordered tuplet includes an availability of clock regions and voltage domains in instances enclosing the logic gate advantageously allowing the ranking to be based at least partially on the availability of the design region for the logical component.

In another embodiment, a computer system includes a processor and a memory, the memory storing instructions for cause the computer system to respond to receiving initial component instance pins annotations annotating the initial component as belonging to a design region based on user specification and connectivity tracing with a design region, the design region being a clock region and global voltage domain pair by performing the steps of propagating a design region forward from the component instance pins to sequential components by assigning a design region to a sequential component based on the design region of a previous component, identifying crossing endpoints where the design region changes, and placing at least one of a fence, power supply rail, and a level translator at the crossing endpoints. The computer system advantageously facilities the performance of the computer implemented method.

In further embodiments, propagating the design region forward from the component instance pins to sequential components includes responsive to a buffer setting the clock region of a design region of the buffer as the clock region of a preceding component and determining the voltage domain using one of a voltage crossing table and a default voltage defined by a user, responsive to a logic gate having a set of inputs and each input having a same design region setting a design region of an output of the logic gate as the same design region and responsive to the logic gate having a set of inputs and at least one input of the set of inputs having a distinct design region from at least one other input of the set of inputs, setting a design region of an output of the logic gate as an optimal design region based at least in part on an integer score of each design region. Propagating the design region forward allows the process to track a design region through the circuit design thereby providing a logical flow tracing of the design regions.

In further embodiments, the integer score of each design region is a lexicographically ordered tuplet advantageously allowing a ranking of the possible design regions.

In further embodiment, the lexicographically ordered tuplet includes at least one of a total number of clock region crossings and a total number of voltage domain crossings from an input of the component to an output of the component, a set of crossing types of clock region crossings and voltage domain crossings, a number of violations of at least one of a set of predetermined fencing compatibility rules, and an availability of clock regions and voltage domains in instances enclosing the logic gate, advantageously allowing for the ranking to incorporate a number of relevant factors.

In a further embodiment, a method includes annotating initial component instance pins as belonging to a design region based on user specification and connectivity tracing with a design region, the design region being a clock region and global voltage domain pair propagating a design region forward from the component instance pins to sequential components by assigning a design region to a sequential component based on the design region of a previous component, identifying crossing endpoints where the design region changes, and placing at least one of a fence, power supply rail, and a level translator at the crossing endpoints. The method advantageously increases an efficiency of circuit designs, and minimizes instances of human error in the same.

In another example, a system includes a computing environment having a computer, the computer including a processor set, a communication fabric, a volatile memory, a persistent storage, and at least one network module, and the persistent storage storing instructions for causing the process set to implement a method including responding to receiving initial component instance pins annotations annotating the initial component as belonging to a design region based on user specification and connectivity tracing with a design region, the design region being a clock region and global voltage domain pair by performing the steps of propagating a design region forward from the component instance pins to sequential components by assigning a design region to a sequential component based on the design region of a previous component, identifying crossing endpoints where the design region changes. The system advantageously increases an efficiency of circuit designs, and minimizes instances of human error in the same.

In further embodiment, propagating the design region forward from the component instance pins to sequential components includes responsive to a buffer setting the clock region of a design region of the buffer as the clock region of a preceding component and determining that the voltage using one of a voltage crossing table and a default voltage defined by a user, responsive to a logic gate having a set of inputs and each input having a same design region setting a design region of an output of the logic gate as the same design region and responsive to the logic gate having a set of inputs and at least one input of the set of inputs having a distinct design region from at least one other input of the set of inputs, setting a design region of an output of the logic gate as an optimal design region based at least in part on an integer score of each design region. Propagating the design region forward allows the process to track a design region through the circuit design thereby providing a logical flow tracing of the design regions.

In further examples, the integer score of each design region is a lexicographically ordered tuplet including at least one of a total number of clock region crossings and a total number of voltage domain crossings from an input of the component to an output of the component, a set of crossing types of clock region crossings and voltage domain crossings, a number of violations of at least one of a set of predetermined fencing compatibility rules, and an availability of clock regions and voltage domains in instances enclosing the logic gate, thereby facilitating a more accurate ranking.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

This disclosure relates to modeling integrated circuits and, more particularly, to the automated addition of power supply rails, fences, and level translators to a modular circuit design.

Computing environment 600 contains an example of an environment for the execution of at least some of the computer code involved in performing the inventive methods, such the automated addition of power supply rails, fences and level translators in a circuit design at block 650. In addition to block 650, computing environment 600 includes, for example, computer 601, wide area network (WAN) 602, end user device (EUD) 603, remote server 604, public Cloud 605, and private Cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI), device set 623, storage 624, and Internet of Things (IoT) sensor set 625), and network module 615. Remote server 604 includes remote database 632. Public Cloud 605 includes gateway 630, Cloud orchestration module 631, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 632. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a Cloud, even though it is not shown in a Cloud in FIG. 6. On the other hand, computer 601 is not required to be in a Cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 21 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in block 650 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 104 represents the machine(s) that collects and store helpful and useful data for use by other computers, such as computer 601. For example, in a hypothetical case where computer 601 is designed and programmed to provide a recommendation based on historical data, then this historical data may be provided to computer 601 from remote database 632 of remote server 04.

PUBLIC CLOUD 605 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 605 is performed by the computer hardware and/or software of Cloud orchestration module 631. The computing resources provided by public Cloud 605 are typically implemented by virtual computing environments that run on various computers making up the computers of host physical machine set 632, which is the universe of physical computers in and/or available to public Cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 631 manages the transfer and storage of images, deploys new instantiations of VCEs and manages active instantiations of VCE deployments. Gateway 630 is the collection of computer software, hardware, and firmware that allows public Cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public Cloud 605, except that the computing resources are only available for use by a single enterprise. While private Cloud 606 is depicted as being in communication with WAN 602, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 605 and private Cloud 606 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Turning now to an overview of technologies that are more specifically relevant to aspects of the invention, modern processor and system-on-chip designs often have multiple voltage domains for a variety of reasons. For example, diverse circuit functions, licensed-in third party modules, and standard interfaces (e.g., PCIe) may all have differing voltage requirements. The need to isolate errors caused by manufacturing defects and/or the need to limit power consumption may require turning off or lowering the voltage supplies to specific voltage domains of an integrated circuit chip. For each such voltage domain, designers must enumerate in the circuit design files statements at the register transfer level that connect the correct power supply rails (i.e., power and ground signals) to each logic design component and route power supply rails to the correct power sources. Designers must also identify signal crossings between voltage domains and include statements in the circuit design files to insert any required devices (e.g., fences or voltage level translators) at those signal crossings. As the number of voltage domains increases in an integrated circuit design, the burden on designers and the probability of bugs in the design concomitantly increase. Bugs introduced at this point in the circuit design may not be caught until late in the design process, for example, when electrical checks are performed.

The present disclosure appreciates that it would be desirable to automate the insertion of voltage rails, fences, and level translators to eliminate the need for designers to manually perform these tasks. The automation of the insertion of voltage rails, fences, and level translators would increase designer productivity, eliminate designer-introduced bugs in these design aspects, create a more consistent and thus debuggable design, and provide flexibility to adapt to changing design requirements without costly redesign.

The present disclosure additionally appreciates that it would also be desirable to similarly automate the insertion of fences at crossings between asynchronous clock domains. Such fences are utilized, for example, to ensure predictability of self-test or manufacturing test operations.

Further, the present disclosure appreciates that it would be desirable to automate the insertion of voltage rails, fences, and level translators into a modular (pre-flattened) representation of the integrated circuit design (e.g., the hardware description language (HDL) files that describe the integrated circuit design) so that all of the automated modifications to the integrated circuit design can be verified using the normal design verification flow, for example, utilizing logic simulation and/or formal verification.

Hardware description languages (HDLs), such as VHDL and Verilog, enable the description of an integrated circuit design in a modular, hierarchical fashion. A module (or “entity/architecture” in VHDL) can describe one component of the modular circuit design by listing instances of subcomponents and the interconnections there between. An instance can be a reference to a primitive circuit component, such as a logic gate or flip-flop, or a reference to another module. In the latter case, the instance, which can be referred to as a “module instance,” “child instance,” or “nonprimitive instance,” directs the circuit construction process (e.g., logic synthesis) to substitute the contents of the referenced module for the instance. A hierarchical circuit design is one in which some module, called the top-level module, instantiates one or more other modules, which may in turn instantiate one or more other modules, and so on. For ease of reference, the present disclosure employs a naming convention in which an instance of a module (or entity) has a name of the form: [instance name]: [module name].

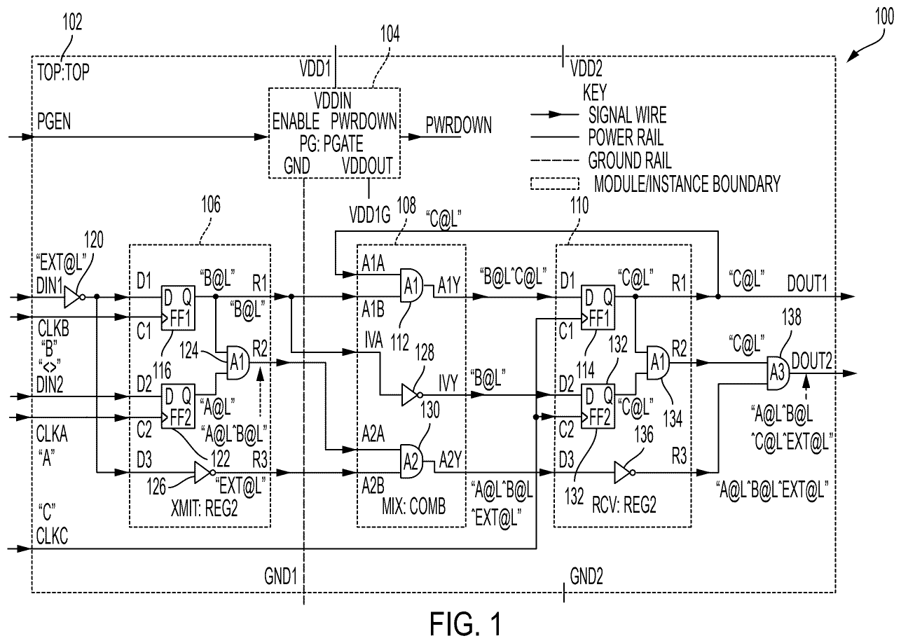

FIG. 1 is a block diagram of an exemplary modular circuit design 100 into which power supply rails, fences, and level translators may be automatically inserted in accordance with one embodiment. In this simple example, modular circuit design 100 includes two hierarchically arranged levels. A top-level module instance 102, named TOP: TOP, instantiates four lower-level instances 104, 106, 108, 110, which are named PG: PGATE, XMIT: REG2, MIX: COMB, and RCV: REG2, respectively. As indicated, modular circuit design 100 includes only single instances of modules PGATE and COMB, but includes two instances of module REG2. In accordance with one aspect of the modular design methodology disclosed herein, all instances of a given module remain identical regardless of the automated updates to modular circuit design 100 made herein, as described further below.

In a typical implementation, each module utilized to construct a modular circuit design is separately described in its own respective HDL file. For example, module TOP may be described in a design file named “top.vhdl”, and module REG2 may be described in a separate design filed named “reg2.vhdl”. Similarly, the contents of modules PGATE and COMB may be defined in separate files (e.g., “pgate.vhdl” and “comb.vhdl”). Although FIG. 1 illustrates the primitive contents of its constituent modules inside the boundary of module TOP, this illustration is made only for the purpose of presenting the overall integrated circuit design. It should be understood that the contents of the constituent modules (e.g., flip-flops FF1 and FF2 in REG2) would actually be enumerated only in the design file “reg2.vhdl” and not in the design file “top.vhdl”. Thus, for example, with respect to module REG2, design file “top.vhdl” would contain only the instances (named XMIT and RCV) that refer to module REG2. The contents of the two instances XMIT and RCV depicted in FIG. 1 are necessarily identical because the contents are defined only once, within design file “reg2.vhdl”.

The inputs and outputs of each module are collectively called ports. Each port corresponds to a pin of each instance of the given module. For example, input port C1 of module REG2 corresponds to pin C1 of instance XMIT: REG2 (which is in turn connected to input port CLKB of module TOP) and to pin C1 of instance RCV: REG2 (which is connected to input port CLKC of module TOP).

The module PGATE represents a gated power supply. When its ENABLE input is driven to a logical ‘1’ value, it will couple power received on its VDDIN port to its VDDOUT port. Otherwise, its VDDOUT port will be in a high-impedance state, meaning that no power is being supplied. Such a gated power supply module can be used, for example, to turn off power to a section of the circuit (called a “voltage island”) when the section is not being used, in order to save power. Module PGATE has a PWRDOWN output port that is driven high (e.g. to ‘1’) whenever the VDDOUT port is not at a stable supply voltage. This output is intended to be used to control fences (also called “isolation cells”) interposed between the voltage island and other parts of a circuit. However, no fences are shown in modular circuit design 100 of FIG. 1. In accordance with one aspect of the disclosed inventions, fences are inserted into modular circuit design 100 in an automated fashion.

Module PGATE is also an example of a “black box.” If a module is designated as a black box by the input specification, the design process described herein will not analyze or modify its contents. Accordingly, any “black box” module must already have all necessary power supply and ground ports, and its internal components must already be connected to the power supply rails as needed.

As further illustrated in FIG. 1, the TOP, REG2, and COMB modules also contain primitive circuit components (e.g., flip-flops and logic gates). For example, the REG2 module includes flip-flops FF1 and FF2, AND gate A1, and an inverter (which are respectively identified by reference numerals 116, 122, 124, and 126 in instance 106 and reference numerals 114, 132, 134, and 136 in instance 110). The COMB module includes AND gates A1 112, inverter 128, and AND gate A2 130. A primitive circuit component is one which cannot be further decomposed into subcomponents and which has a single power and ground terminal. A primitive circuit component may correspond to an assignment statement in an HDL. In this case, the inputs of the component are the signals referenced by the assignment statement, and the outputs are the signals being assigned.

One aspect of the design process described herein is to assign each primitive circuit component (that does not reside within a black box) to a single voltage domain and to connect its power and ground terminals to the power and ground rails of its voltage domain. Even if the primitive circuit component is later replaced or combined with other primitive circuit components by the circuit construction process (e.g., in logic synthesis), the circuit construction process should be able to identify the voltage domain associated with the original component in order to properly make such changes.

In at least some embodiments, the design process distinguishes two types of primitive components: clocked and non-clocked. A clocked primitive component (CPC) has a clock input pin that is attached to a clock signal. A CPC is typically either a storage element (e.g., a latch or flip-flop) or part of a clock distribution network (e.g., a buffer, clock multiplexer, or clock divider). In cases in which a primitive component has multiple clock inputs (such as a clock multiplexer) exactly one input must be designated as the “classifying input,” meaning that the primitive component will be powered based on the clock domain driving that classifying input.

Modular circuit design 100 of FIG. 1 has two top-level power supply ports, called VDD1 and VDD2, and two corresponding ground ports, called GND1 and GND2. (In other cases, a circuit design can have only one ground port for multiple power supplies.) Modular circuit design 100 also has an internal gated power supply signal, called VDD1G. Other than the connections to gated power supply instance 104, there are no connections from the power and ground ports to internal components.

In at least some embodiments, the automated insertion of power supply rails, fences, and level translators is controlled by an input specification. In some examples, the input specification has two parts: a global specification and an optional module-specific specification. In some examples, the global specification includes two tables: a Global Domain Definition (GDD) table and a Global Domain Crossing Constraints (GDCC) table.

Table I below is an example of a GDD table. The GDD table defines four global clock domains, named EXT, CLKA, CLKB, and CLKC; three global power domains, named VDD1, VDD1G, and VDD2; and two global ground domains, named GND1 and GND2. Each clock domain is assigned one power domain, and each power domain is assigned one ground domain. Thus, there must be an N-to-1 mapping from clock to power domains and from power to ground domains.

TABLE I
Global Domain Definition
(GDD) table

| Clock | Power | Ground |
|---|---|---|
| EXT | VDD1 | GND1 |
| CLKA | VDD1 | GND1 |
| CLKB | VDD1G | GND1 |
| CLKC | VDD2 | GND2 |

Table II below shows an example of a GDCC table. The GDCC table specifies, for every permutation of two global clock domains, what constraints apply to signals that cross from the first domain to the second domain.

TABLE II
Global Domain Crossing Constraints (GDCC) table

| Clock | Allow | | |
|---|---|---|---|
| Domain Crossing | FALSE | | |
| Source Domain → | | | Fence |
| Sink Domain | Handling | Crossing? | Control |
| EXT → CLKA | DIRECT | yes | N/A |
| EXT → CLKB | DIRECT | NO | N/A |
| EXT → CLKC | ILLEGAL | N/A | N/A |
| CLKA → EXT | ILLEGAL | N/A | N/A |
| CLKA → CLKB | DIRECT | NO | N/A |
| CLKA → CLKC | TRANS | yes | none |
| CLKB → EXT | ILLEGAL | N/A | N/A |
| CLKB → CLKA | FENCE-OUT | yes | PWRDOWN |
| CLKB → CLKC | TRANS | yes | PWRDOWN |
| CLKC → any | ILLEGAL | N/A | N/A |

In Table II, three types of constraints are shown in columns 2, 3 and 4. Column 2 specifies the handling of the domain crossings indicated by column 1. The values of handling have the following meanings:

DIRECT: there are no constraints on the given crossing, meaning no fence or level translator is needed;

ILLEGAL: the crossing is not allowed. If such a crossing is detected in the design, the crossing is reported as a design error, but will not be modified.

TRANS: the crossing requires a level translator.

FENCE-IN: the crossing requires a fence powered by the input (source) domain.

FENCE-OUT: the crossing requires a fence powered by the output (sink) domain.

Column 3 of Table II specifies whether or not false crossings between clock domains are allowed. A false crossing occurs if a port or primitive component is classified in a clock domain such that there is a crossing to or from a different clock domain that would not have otherwise existed. For example, consider AND gate A1 112 inside instance MIX: COMB 108 in FIG. 1. If AND gate A1 112 is classified in the CLKB domain, then the path from flip-flop FF1 114 of instance 110 (named RCV: REG2) to AND gate A1 112 would be a crossing from the CLKC domain to the CLKB domain. (Flip-flop FF1 114 is in the CLKC domain because its clock pin is connected to clock signal CLKC.) This signal crossing would be a “false crossing” because the signal crossing is created by the clock domain assignment and not by the design topology. That is, without the clock domain assignment, there would not necessarily be any CLKC-to-CLKB crossing present in modular circuit design 100. A CLKC-to-CLKB crossing is disallowed by the input specification shown in Table II, which prevents assignment of the AND gate A1 112 in module instance 108 (i.e., MIX: COMB) to the CLKB domain. Instead, AND gate A1 112 is assigned to the CLKC domain. This assignment will result in a clock domain crossing from flip-flip FF1 116 inside instance 106 (named XMIT: REG2), which is in the CLKB domain (due to its clock pin being connected to clock signal CLKB), to AND gate A1 112, which is in the CLKC domain. This clock domain assignment is not a false crossing because there is already a CLKB-to-CLKC crossing from flip-flop FF1 116 to flip-flop FF1 114.

Column 4 of Table II specifies which top-level signal should be connected to a fence or level translator to control when the fence or level translator is in an isolation state (blocking transmissions from input to output). In the case of a level translator, such a control is optional. If not present, indicated by the word “none” in Column 4 of Table II, the level translator will always transmit signals from input to output. In this case, the level translator's fence control input pin will be tied inactive.

The GDCC table may optionally contain other fields to further constrain or direct the treatment of each crossing. For example, these further constraints can include which type of fence or level translator component to use or whether to place a fence or level translator closer to the source or sink of a crossing.

In addition to the global specification, the input specification may include optional module-specific specifications. Such specifications may include whether a given module is to be treated as a black box, in which clock domains certain ports or components should be classified, or where to place fences or level translators. In general, the automated design tool allows the user to manually override its automated decisions.

Those skilled in the art will appreciate that it is not necessary for the GDCC table to explicitly list every permutation of domains. For example, in some embodiments, a default handling (e.g., of illegal) may be implied for any permutation not listed. Furthermore, in some embodiments, it may be sufficient for the GDCC table to list constraints by permutations of voltage domains instead of or in addition to permutations of clock domains. For example, if there is no variation of constraints among the clock domains associated with a given voltage domain, it may be sufficient to list only the given voltage domain. In addition, an embodiment may establish an order of precedence such that a first constraint referencing a clock domain takes precedence over a second constraint referencing the voltage domain associated with the clock domain.

In existing automated circuit designs, the modular circuit design includes a mapping from global clock domains to global voltage domains. A processor assigns, to a first instance of a clocked primitive component, a global voltage domain based on which global clock domain clocks the first instance, automatically adds, to the modular circuit design, first power supply rails to power the first instance, and connects the first power supply rails from the first instance to a first power supply for a first global voltage domain The processor assigns, to a second instance of the clocked primitive component, a second global voltage domain based on which global clock domain clocks the second instance, automatically adds second power supply rails to power the second instance, and connects the second power supply rails to a second power supply for a second global voltage domain The processor may then perform further processing, for example, by storing, in data storage, output design files describing the updated modular circuit design.

Such a design operates on the assumption that every global clock domain maps to a single global voltage domain. In some circuit designs, this assumption is not accurate, and following this assumption can result in voltage domain and/or clock domain violations.

In automated circuit design systems where a global clock domain can map to multiple different global voltage domains, the automated circuit design system accounts for the discrepancy by annotating design nets using accounts for the discrepancy by annotating design nets using unique pairings of clock domains (CR) and voltage domains (VD).

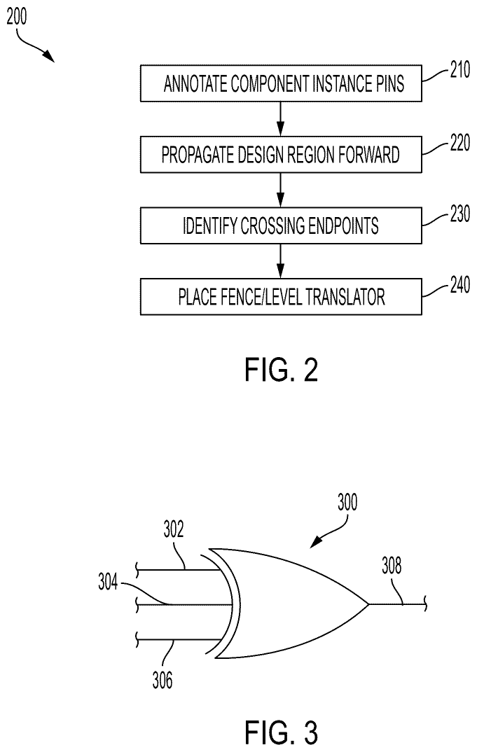

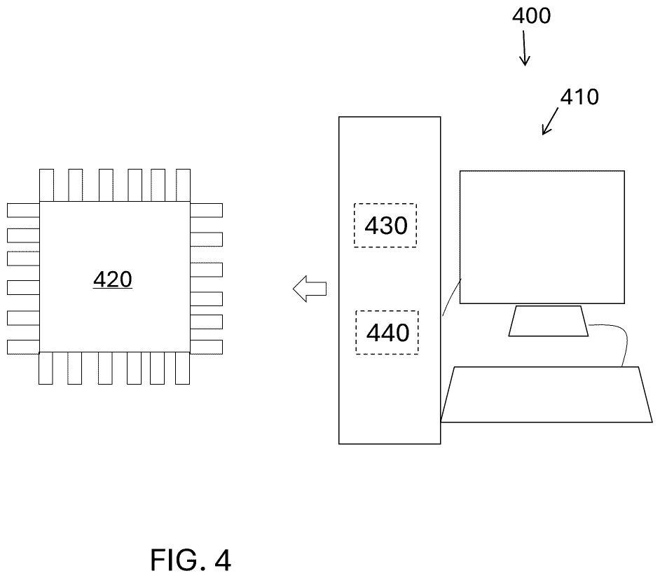

Turning now to a more detailed description of aspects of the present invention, FIG. 2 depicts a high level process 200 flow for automating fence and level translator placements in a circuit design according to embodiments of the invention. Initially the process annotates instance pins of a starting component in an Annotate Component Instance Pins Step 210. The annotation uses a user specification and connectivity tracing to identify a clock region/global voltage domain pair to which the component belongs. The clock region/global voltage domain pair is referred to as a Design Region (DR).

The annotate component instance pins step 210 assigns a design region at each clock source, as well as at any specific pins having design regions explicitly defined by a circuit designer. In addition, components that are defined black boxes (e.g., a set of sub components defining a number of pin ins and pin outs with a corresponding function) have design regions assigned at the black box boundary based on the clock connectivity of the black box and on user specifications for non-clock pins.

Once the instance pins of the component are annotated with a design region, the process 200 propagates the design region forward in a Propagate Design Region Forward step 220. The design region is propagated forward by tracking the pin connections and applying the design region annotation to each sequential component encountered in the circuit.

When the sequential component is a buffer, the port connections for the clock region component never changes, but the voltage component may change if voltage is excluded from the region. When this occurs, the resultant voltage is decided using a voltage crossing table and default voltages defined by the user.

When the sequential component is a logic gate that has a single design region corresponding to the inputs, that design region is propagated forward from the output of the logic gate. Propagation in this manner is referred to as being based on a fanout set design region for the output net of the logic gate.

When the sequential component is a logic gate having inputs that span multiple distinct design regions, the process 200 selects a design region based on a cost integer tuplet for each result candidate. The cost of a result voltage domain or a clock region candidate is a tuplet counting a number of occurrences for multiple factors. This is referred to as the cost integer tuplet (alternatively as the tuplet). In one example, for clock regions the factors include a number of region selection rules violations, a number of fence compatibility violations, a number of non-direct crossings from nonmodifiable source clock regions, a number of potential fence compatibility violations, a number of unavailable clock region results, a number of illegal crossings, a number of instances where a result clock region is not a source clock region, a number of instances where fences are needed for both a source and sink side of a given logic component, a number of illegal crossings on the source side, a number of fences needed on the source side, and a number of direct but not identical crossings on both a source and sink side of the logical component. In one example, for voltage domains, the factors include a number of illegal crossings, a number of level translators or electric fences needed for both the source and sink side of the logic component, a number of illegal crossings on the source side, a number of level translators or electric fences needed on the source side, and a number of direct but not identical crossings on both a source and sink side of the logic component. It is appreciated that alternative examples can include some, all, and/or additional factors and still fall within the instant disclosure.

FIG. 3 illustrates one such logic gate as an XOR gate 300 including three inputs 302, 304, 306 and an output 308. The first input 302 includes a design region at a first clock region and a first voltage level, the second input 304 includes a design region at the first clock region and a second voltage level, different from the first voltage level, and the third input 306 includes a design region at a second clock region and a third voltage level.

The cost integer tuplet forms a score as an integer tuplet that is organized lexicographically. Each design region corresponding to at least one input of the logic gate is a result candidate. The cost integer identifies the optimal result candidate for the design region of the output 308 pin. The value of the cost integer depends on a set of sink design regions and available clock regions, each of which is collected separately. In some examples, the cost integer tuplet does not utilize any connectivity or tracing information in identifying the optimal design region.

In some examples, the value of the cost integer (the score) includes the number of clock regions and voltage crossings traversed from an input of the logic gate to the clock region and voltage level of the design region (separating a number of identical, direct, and illegal crossings).

In other examples, the value of the cost integer can include the clock region and voltage crossing types from the candidate clock region and voltage level to the clock region and voltage level coordinates of the fanout design region set (separating the number of identical direct, and illegal crossings).

In yet other examples, the value of the cost integer can include the number of violations to predetermined fencing compatibility rules and/or the availability of the clock region and voltages in instances enclosing the processed logic gate.

In yet further examples, the value of the cost integer can be a combination of each of the factors.

The propagation of the design region is carried forward until there are no further sequential components, after which the propagation is reiterated beginning at a different initial component.

After propagation is completed, the process 200 identifies crossing endpoints in an Identify Crossing Endpoints step 230. Crossing endpoints are identified for both the clock region and the voltage level, and are identified at any point where the design region changes. Once identified, a fence or level translator is placed at the location with the object being placed being dependent on which portion (clock region or voltage level) of the design region changed, in a Place Fence/Level Translator step 240.

In some examples, the process 200 can further identify and provide information characterizing the crossings into different sets and subsets of crossings based on one or more relevant characteristics. In one example, after having identified all crossings within a design, the process creates a list that includes all the crossings associated with a given attribute. This is repeated for multiple attributes to create multiple sets of crossings. This information is then provided to subsequent physical design processes and utilized to aid the physical design.

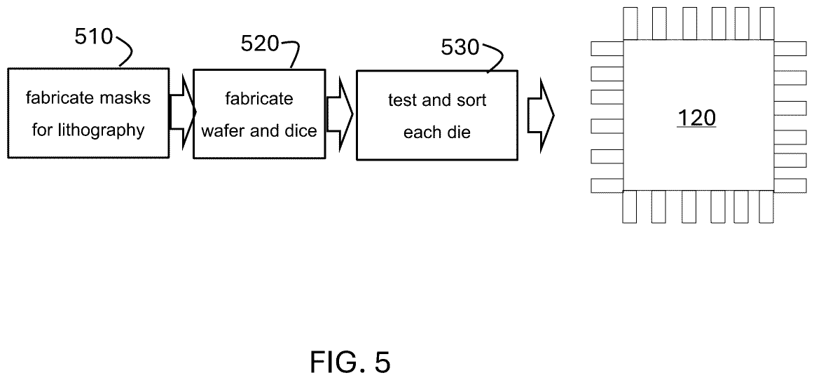

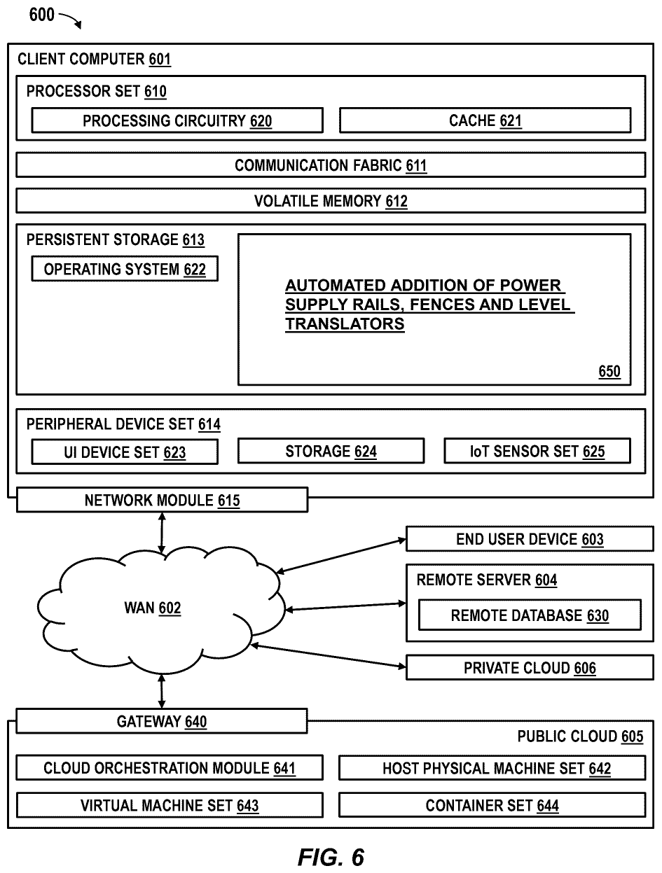

FIG. 1 is a block diagram of a system 100 to perform the process of automatically or semi-automatically inserting power supply rails, fences, and level translators according to embodiments of the invention. The system 100 includes processing circuitry 110 used to generate the design that is ultimately fabricated into an integrated circuit 120. The steps involved in the fabrication of the integrated circuit 120 are well-known and briefly described herein. Once the physical layout is finalized, based, in part, on the placement of the power supply rails, fences, and level translators according to embodiments of the invention to facilitate optimization of the routing plan, the finalized physical layout is provided to a foundry. Masks are generated for each layer of the integrated circuit based on the finalized physical layout. Then, the wafer is processed in the sequence of the mask order. The processing includes photolithography and etch. This is further discussed with reference to FIG. 5.

FIG. 5 is a process flow of a method of fabricating the integrated circuit according to exemplary embodiments of the invention. Once the physical design data is obtained, based, in part, on the automatically or semi-automatically inserting power supply rails, fences, and level translators, the integrated circuit 120 can be fabricated according to known processes that are generally described with reference to FIG. 5. Generally, a wafer with multiple copies of the final design is fabricated and cut (i.e., diced) such that each die is one copy of the integrated circuit 120. At block 510, the processes include fabricating masks for lithography based on the finalized physical layout. At block 520, fabricating the wafer includes using the masks to perform photolithography and etching. Once the wafer is diced, testing and sorting each die is performed, at block 530, to filter out any faulty die.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for automating addition of power supply rails, fences, and level translators in a circuit design, comprising:
annotating initial component instance pins as belonging to a design region based on user specification and connectivity tracing with a design region, the design region being a clock region and global voltage domain pair;
propagating a design region forward from the component instance pins to sequential components by assigning a design region to a sequential component based on the design region of a previous component;
identifying crossing endpoints where the design region changes; and
placing at least one of a fence, power supply rail, and a level translator at the crossing endpoints.

2. The computer-implemented method of claim 1, wherein the initial component instance pins are clock sources.

3. The computer-implemented method of claim 1, wherein propagating the design region forward from the component instance pins to sequential components includes:
responsive to a buffer setting the clock region of a design region of the buffer as the clock region of a preceding component and determining that a voltage using one of a voltage crossing table and a default voltage defined by a user; and
responsive to a logic gate having a set of inputs and each input having a same design region setting a design region of an output of the logic gate as the same design region.

4. The computer-implemented method of claim 1, wherein propagating the design region forward from the component instance pins to sequential components includes
responsive to a buffer setting the clock region of a design region of the buffer as the clock region of a preceding component and determining that a voltage using one of a voltage crossing table and a default voltage defined by a user; and
responsive to the logic gate having a set of inputs and at least one input of the set of inputs having a distinct design region from at least one other input of the set of inputs, setting a design region of an output of the logic gate as an optimal design region based at least in part on an integer score of each design region.

5. The computer-implemented method of claim 4, wherein the integer score of each design region is a lexicographically ordered tuplet.

6. The computer-implemented method of claim 5, wherein the lexicographically ordered tuplet includes a total number of clock region crossings and a total number of voltage domain crossings from an input of the component to an output of the component.

7. The computer-implemented method of claim 5, wherein the lexicographically ordered tuplet includes a set of crossing types of clock region crossings and voltage domain crossings.

8. The computer-implemented method of claim 5, wherein the lexicographically ordered tuplet includes a number of violations of at least one of a set of predetermined fencing compatibility rules.

9. The computer-implemented method of claim 5, wherein the lexicographically ordered tuplet includes an availability of clock regions and voltage domains in instances enclosing the logic gate.

10. A computer program product for causing a computer system to perform a method including:
receiving initial component instance pins annotations the initial component as belonging to a design region based on user specification and connectivity tracing with a design region, the design region being a clock region and global voltage domain pair;
propagating a design region forward from the component instance pins to sequential components by assigning a design region to a sequential component based on the design region of a previous component;
identifying crossing endpoints where the design region changes; and
placing at least one of a fence, power supply rail, and a level translator at the crossing endpoints.

11. The computer program product of claim 10, wherein the initial component instance pins are clock sources.

12. The computer program product of claim 10, wherein propagating the design region forward from the component instance pins to sequential components includes:
responsive to a buffer setting the clock region of a design region of the buffer as the clock region of a preceding component and determining that the voltage using one of a voltage crossing table and a default voltage defined by a user;
responsive to a logic gate having a set of inputs and each input having a same design region setting a design region of an output of the logic gate as the same design region; and
responsive to the logic gate having a set of inputs and at least one input of the set of inputs having a distinct design region from at least one other input of the set of inputs, setting a design region of an output of the logic gate as an optimal design region based at least in part on an integer score of each design region.

13. The computer program product of claim 12, wherein the integer score of each design region is a lexicographically ordered tuplet.

14. The computer program product of claim 13, wherein the lexicographically ordered tuplet includes a total number of clock region crossings and a total number of voltage domain crossings from an input of the component to an output of the component.

15. The computer program product of claim 13, wherein the lexicographically ordered tuplet includes a set of crossing types of clock region crossings and voltage domain crossings.

16. The computer program product of claim 13, wherein the lexicographically ordered tuplet includes a number of violations of at least one of a set of predetermined fencing compatibility rules.

17. The computer program product of claim 13, wherein the lexicographically ordered tuplet includes an availability of clock regions and voltage domains in instances enclosing the logic gate.

18. A computer system comprising:
a processor and a memory, the memory storing instructions for cause the computer system to respond to receiving initial component instance pins annotations annotating the initial component as belonging to a design region based on user specification and connectivity tracing with a design region, the design region being a clock region and global voltage domain pair by performing the steps of:
propagating a design region forward from the component instance pins to sequential components by assigning a design region to a sequential component based on the design region of a previous component;
identifying crossing endpoints where the design region changes; and
placing at least one of a fence, power supply rail, and a level translator at the crossing endpoints.

19. The computer system of claim 18, wherein propagating the design region forward from the component instance pins to sequential components includes:
responsive to a buffer setting the clock region of a design region of the buffer as the clock region of a preceding component and determining the voltage domain using one of a voltage crossing table and a default voltage defined by a user;
responsive to a logic gate having a set of inputs and each input having a same design region setting a design region of an output of the logic gate as the same design region; and
responsive to the logic gate having a set of inputs and at least one input of the set of inputs having a distinct design region from at least one other input of the set of inputs, setting a design region of an output of the logic gate as an optimal design region based at least in part on an integer score of each design region.

20. The computer system of claim 19, wherein the integer score of each design region is a lexicographically ordered tuplet.

21. The computer system of claim 20, wherein the lexicographically ordered tuplet includes at least one of a total number of clock region crossings and a total number of voltage domain crossings from an input of the component to an output of the component, a set of crossing types of clock region crossings and voltage domain crossings, a number of violations of at least one of a set of predetermined fencing compatibility rules, and an availability of clock regions and voltage domains in instances enclosing the logic gate.

22. A method comprising:
annotating initial component instance pins as belonging to a design region based on user specification and connectivity tracing with a design region, the design region being a clock region and global voltage domain pair;
propagating a design region forward from the component instance pins to sequential components by assigning a design region to a sequential component based on the design region of a previous component;
identifying crossing endpoints where the design region changes; and
placing at least one of a fence, power supply rail, and a level translator at the crossing endpoints.

23. A system comprising:
a computing environment having a computer, the computer including a processor set, a communication fabric, a volatile memory, a persistent storage, and at least one network module; and
the persistent storage storing instructions for causing the process set to implement a method including responding to receiving initial component instance pins annotations annotating the initial component as belonging to a design region based on user specification and connectivity tracing with a design region, the design region being a clock region and global voltage domain pair by propagating a design region forward from the component instance pins to sequential components by assigning a design region to a sequential component based on the design region of a previous component, identifying crossing endpoints where the design region changes.

24. The system of claim 23, wherein propagating the design region forward from the component instance pins to sequential components includes:
responsive to a buffer setting the clock region of a design region of the buffer as the clock region of a preceding component and determining that the voltage using one of a voltage crossing table and a default voltage defined by a user;
responsive to a logic gate having a set of inputs and each input having a same design region setting a design region of an output of the logic gate as the same design region; and
responsive to the logic gate having a set of inputs and at least one input of the set of inputs having a distinct design region from at least one other input of the set of inputs, setting a design region of an output of the logic gate as an optimal design region based at least in part on an integer score of each design region.

25. The system of claim 24, wherein the integer score of each design region is a lexicographically ordered tuplet including at least one of a total number of clock region crossings and a total number of voltage domain crossings from an input of the component to an output of the component, a set of crossing types of clock region crossings and voltage domain crossings, a number of violations of at least one of a set of predetermined fencing compatibility rules, and an availability of clock regions and voltage domains in instances enclosing the logic gate.
